(19) United States
(12) Patent Application Publication
(10) Pub. No.: US 2017/0063781 A1
(43) Pub. Date: Mar. 2, 2017

(54) SIGNALING CONTROL SYSTEM AND METHOD FOR USE IN NAT TRAVERSAL SYSTEM

(71) Applicant: Institute For Information Industry, Taipei (TW)

(72) Inventors: Whai-En CHEN, Yilan City (TW); Bo-En CHEN, Zhubei City (TW); Chih-Wei SU, Taipei City (TW)

(21) Appl. No.: 15/243,578

(22) Filed: Aug. 22, 2016

Related U.S. Application Data
(60) Provisional application No. 62/209,345, filed on Aug. 25, 2015.

(51) Int. Cl. H04L 29/12; H04L 29/08; H04L 12/66

(52) U.S. Cl. CPC H04L 61/2521; H04L 12/66; H04L 67/141

(57) ABSTRACT

A signaling control system for use in a NAT traversal system includes a registrar server and an application layer gateway server. The registrar server is configured to record registration information of two user terminals. The application layer gateway server is configured to determinate whether the two user terminals are located under a same network address translation device according to the registration information during a process where the two user terminals create a session connection, and forward respective session description protocol information of the two user terminals to each other if it is determined that the two user terminals are located under the same network address translation device.

### PRIORITY

This application claims priority to U.S. Provisional Patent Application No. 62/209,345 filed on Aug. 25, 2015, which is hereby incorporated herein by reference in its entirety.

### FIELD

The present invention relates to a signaling control system and a signaling control method. More particularly, the present invention relates to a signaling control system and a signaling control method for use in a network address translation (NAT) traversal system.

### BACKGROUND

With development of Internet apparatuses, how to solve the problem of Internet Protocol (IP) address shortage becomes increasingly more important. Two possible solutions to this problem are the network address translation traversal (NAT traversal) technology and the Internet Protocol 6^{th} Version (IPv6). Because use of IPv6 has not become popular yet, the NAT traversal technology that allows a plurality of apparatuses to share one common IP address via a NAT apparatus has become the main solution to this problem.

In the Internet world, various data flows between the caller and the callee are defined as sessions, and the Session Description Protocol (SDP) is a protocol for defining the sessions. The purpose of SDP is to provide description information necessary for sessions between the caller and the callee so as to facilitate the caller and the callee in performing the sessions.

For the conventional NAT traversal technology, two user terminals located under a same NAT device (i.e., within a same private network) cannot perform a session directly. Instead, the session between the two user terminals must be performed through agency of a signaling control system located in a public network. In detail, the caller located under a NAT device must firstly transmit a dataflow (pure data or control information) to the NAT device. The NAT device performs an Internet Protocol/User Dataflow Communication Protocol (IP/UDP) conversion on the dataflow, and transmits the converted dataflow to a signaling control system located in a public network. The signaling control system plays the role of an agent for the caller via a Real-Time Transport Protocol (RTP) proxy server and transmits the packet with the SDP information of itself to the NAT device.

The NAT device performs an IP/UDP reverse conversion on the packet and transmits the converted packet and the SDP information of the signaling control system to the callee located under the NAT device. Therefore, for the conventional NAT traversal technology, transmitting a dataflow from any user terminal to another user terminal which are located under the same NAT device must be done through at least four times of transmission and three times of transition (i.e., the two times of conversion by the NAT device and the one time of agency by the signaling control system).

From the viewpoint of data transmission, more times of data transmission or more times of data transition represents a longer data transmission latency and a higher probability of data loss. Accordingly, there is an objective in the art to make an improvement on the conventional NAT traversal technology so that the times of transmission and the times of transition necessary for dataflow transmission between any two user terminals located under a same NAT device can be reduced.

### SUMMARY

The disclosure includes a signaling control system for use in a network address translation (NAT) traversal system. The signaling control system may comprise a registrar server and an application layer gateway server. The registrar server may be configured to record first registration information of a first user terminal and second registration information of a second user terminal. The application layer gateway server may be configured to determine whether the first user terminal and the second user terminal are located under a same NAT device according to the first registration information and the second registration information during the process where the first user terminal and the second user terminal create a session connection, and to forward first session description protocol (SDP) information of the first user terminal to the second user terminal and forward second SDP information of the second user terminal to the first user terminal if it is determined that the first user terminal and the second user terminal are located under the same NAT device.

The disclosure also includes a signaling control method for use in a NAT traversal system. The signaling control method may comprise: recording by a signaling control system first registration information of a first user terminal and second registration information of a second user terminal; and determining by the signaling control system whether the first user terminal and the second user terminal are located under a same NAT device according to the first registration information and the second registration information during the process where the first user terminal and the second user terminal create a session connection, and forwarding by the signaling control system first SDP information of the first user terminal to the second user terminal and second SDP information of the second user terminal to the first user terminal if it is determined that the first user terminal and the second user terminal are located under the same NAT device.

Unlike the conventional NAT traversal technology, the various aspects and embodiments of the present invention can determine whether the caller (e.g., the first user terminal) and the callee (e.g., the second user terminal) are located under a same NAT device according to registration information of the caller and the callee. If it is determined that the caller and the callee are located under the same NAT device, then the various aspect and embodiments of the present invention can forward the SDP information of the caller to the callee directly and forward the SDP information of the callee to the caller directly. In such a way, once a session connection has been created between the caller and the callee, the caller and the callee can communicate with each other directly without the need of agency of the signaling control system and translation by the NAT device. In other words, the various aspects and embodiments of the present invention allow any two user terminals located under a same NAT device to communicate with each other directly. Thereby, as compared with the conventional NAT traversal technology, the times of transmission and the times of transition that need to be experienced during a session between the two user terminals can be effectively reduced.

What is described above presents a summary of some aspects of the present invention (including the problem to be solved, the means to solve the problem and the effect of the present invention) to provide a basic understanding of these aspects. However, this is not intended to encompass all aspects of the present invention. Additionally, what described above is neither intended to identify key or essential elements of any or all aspects of the present invention, nor intended to describe the scope of any or all aspects of the present invention. This summary is provided only to present certain concepts of some aspects of the present invention in a simple form and as an introduction to the following detailed description.

The detailed technology and preferred embodiments implemented for the subject invention are described in the following paragraphs accompanying the appended drawings for people skilled in this art to well appreciate the features of the claimed invention.

### BRIEF DESCRIPTION OF THE DRAWINGS

FIG. 1 illustrates a framework of a NAT traversal system according to one or more embodiments of the present invention;

FIG. 2 illustrates a way in which user terminals register in the NAT traversal system according to one or more embodiments of the present invention;

FIG. 3 illustrates a way in which the NAT traversal system operates according to one or more embodiments of the present invention;

FIG. 4 illustrates information included in the invitation signals and the response signals shown in FIG. 3 according to one or more embodiments of the present invention; and

FIG. 5 illustrates a signaling control method for use in a NAT traversal system according to one ore more embodiments of the present invention.

### DETAILED DESCRIPTION

One or more example embodiments described hereinafter are not intended to limit the present invention to any specific examples, embodiments, environment, applications, structures, processes or steps described in these example embodiments. In the attached drawings, elements unrelated to the present invention are omitted from depiction. In the attached drawings, dimensions of individual elements and dimensional scales among the individual elements are illustrated only as examples, but not to limit the present invention. Unless otherwise stated, same (or similar) reference numerals correspond to same (or similar) elements in the following descriptions.

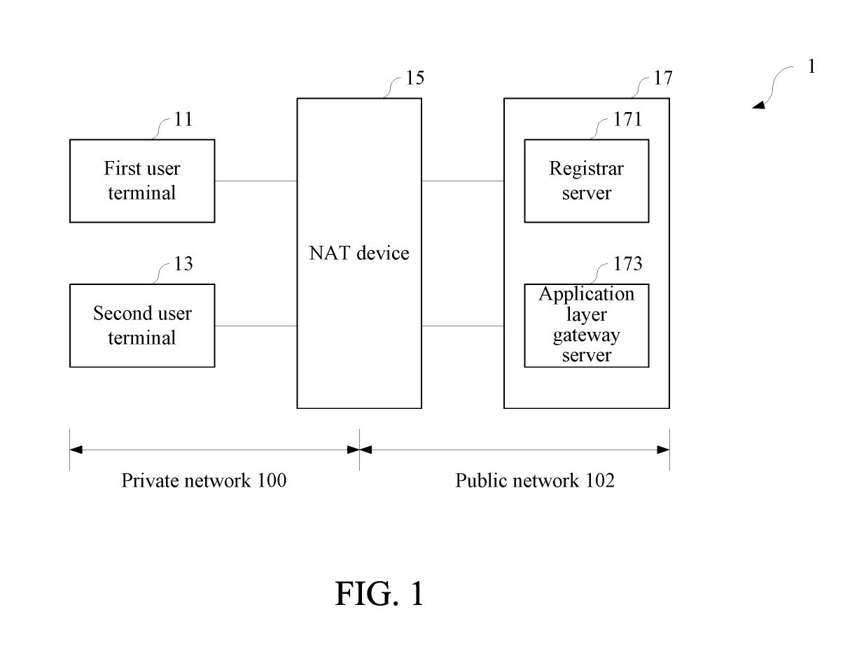

One or more embodiments of the present invention may be a signaling control system for used in a NAT traversal system. The signaling control system will be described hereinafter as an example with FIG. 1, but this example is not a limitation. FIG. 1 illustrates a framework of a NAT traversal system according to one or more embodiments of the present invention. Referring to FIG. 1, a NAT traversal system 1 may comprise a first user terminal 11, a second user terminal 13, a NAT device 15 and a signaling control system 17. The signaling control system 17 may comprise a registrar server 171 and an application layer gateway server 173. Both the first user terminal 11 and the second user terminal 13 are located under the NAT device 15; that is, the first user terminal 11 and the second user terminal 13 are located in a same private network 100. The signaling control system 17 is located outside the NAT device 15; that is, the signaling control system 17 is located in a public network 102.

The NAT traversal system 1 may be applied to various communication network environments. For ease of description, the NAT traversal system 1 will be described hereinafter as an example with a communication network environment formulated by a 3GPP technical specification, but this example is not a limitation to the NAT traversal system 1. Under the 3GPP technical specification (e.g., TS 23.228 and TS 23.334), the signaling control system 15 may act as a part of or the whole of an IP Multimedia Subsystem (IMS). The IMS is a framework that provides voice and multimedia services based on an IP network. The IMS may comprise such functions as a Call Session Control Function (CSCF), an IMS-Application-Layer Gateway (IMS-ALG), and an IMS-Access Gateway (IMS-AGW).

Each of the first user terminal 11 and the second user terminal 13 may be one of various portable electronic communication devices, such as a mobile phone, a digital camera, a notebook computer, a tablet computer, etc. Each of the first user terminal 11 and the second user terminal 13 may also be one of various non-portable electronic communication devices, such as a desktop computer, a smart household appliance, etc. The NAT device 15 may be one of various known NAT devices. For example, he NAT device 15 may be a symmetrical type NAT device, an asymmetrical type NAT device or any other derivative type NAT device of them.

Before performing a session between the first user terminal 11 and the second user terminal 13, they must register with the signaling control system 17 respectively so that the signaling control system 17 can acquire the registration information of the first user terminal 11 and the second user terminal 13. Then, once an invitation signal is received by the signaling control system 17, the signaling control system 17 can identify the caller that initiated the invitation signal and the callee that ought to receive the invitation signal, and provide relevant services and processes to the caller and the callee.

The registrar server 171 may be configured to record first registration information of the first user terminal 11 and second registration information of the second user terminal 13. For example, the registrar server 171 may be a computer device capable of providing registration for the first user terminal 11 and the second user terminal 13. The computer device may have various computing elements (e.g., processors, microprocessors, etc) for executing various logic operations. The computer device may have various storage elements (e.g., memories, hard disks, etc.) for storing various data. The computer device may have various input/output elements (e.g., mice, keyboards, user interfaces, screens, etc) for receiving data from the outside and outputting data to the outside. The computer device may register the first user terminal 11 and the second user terminal 13 via elements such as the aforesaid computing elements, storage elements, and input/output elements according to a processing flow constructed by software, firmware, a program, an algorithm or the like.

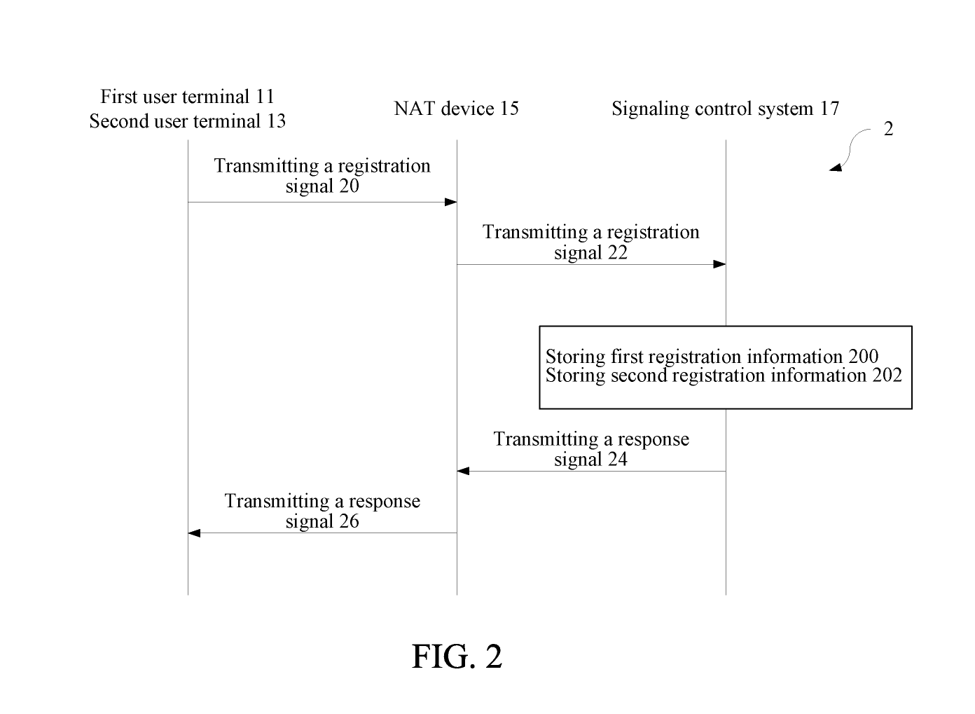

A way in which the first user terminal 11 and the second user terminal 13 register with the registrar server 171 respectively will be described hereinafter as an example with FIG. 2, but this example is not an limitation. FIG. 2 illustrates a way 2 in which the first user terminal 11 and the second user terminal 13 in the NAT traversal system 1 are registered according to one or more embodiments of the present invention. Referring to FIG. 1 and FIG. 2, the registration of the first user terminal 11 may begin with a registration signal 20 initiated by the first user terminal 11. Because the first user terminal 11 and the signaling control system 17 are located in different networks (i.e., one is located in a private network 100 and another one is located in a public network 102), transmission of the registration signal 20 from the first user terminal 11 to the registrar server 171 of the signaling control system 17 must be done through the NAT device 15.

The registration signal 20 may comprise IP/UDP information and Session Initiation Protocol (SIP) information. The IP/UDP information may be a variety of IP/UDP-based information, including but not limited to the connection location information of the first user terminal 11 and the signaling control system 17 in the network layer and the transport layer. For example, “IP_{UE1}/P_{SIP1}” (corresponding to the IP address/port number of the first user terminal 11) may be recorded in a Src Header Field, and “IP_{IMS}/P_{IMS}” (corresponding to the IP address/port number of the signaling control system 17) may be recorded in a Dst Header Field. The SIP information may be a variety of IP/UDP-based information, including but not limited to the identification (ID) information and contact information of the first user terminal 11. For example, “UE1@IMS” may be recorded in a Request-URI Header Field to identify the first user terminal 11, and “UE1@IP_{UE1}/P_{SIP1}” may be recorded in a Contact Header Field to provide a connection location of the first user terminal 11 in the application layer.

After receiving the registration signal 20, the NAT device 15 may generate a registration signal 22 by translating the IP address/port number IP_{-UE1}/P_{SIP1} recorded in the Src Header Field into the IP address/port number IP_{NAT}/P′_{SIP1} of the NAT device 15 (that is, translating the IP address/port number IP_{UE1}/P_{SIP1} that are identifiable to the private network 100 into the IP address/port number IP_{NAT}/P′_{SIP1} that are identifiable to the public network 102), and then transmits the registration signal 22 to the signaling control system 17. Additionally, the NAT device 15 may store in a Mapping Table a mapping between the IP address/port number IP_{UE1}/P_{SIP1} of the first user terminal 11 and the IP address/port number IP_{NAT}/P′_{SIP1} of the NAT device 15 (e.g., represented as “IP_{UE1}/P_{SIP1}←→IP_{NAT}/P′_{SIP1}”).

After receiving the registration signal 22, the registrar server 171 may process the registration request of the first user terminal 11, and store first registration information 200 of the first user terminal 11. For example, the registrar server 171 may learn that the IP address/port number IP_{UE1}/P_{SIP1} recorded in the Contact Header Field is different from the IP address/port number IP_{NAT}/P′_{SIP1} recorded in the Src Header Field by comparing the IP/UDP information with the SIP information, and accordingly determine that the registration signal 22 is actually transmitted by the first user terminal 11 via the NAT device 15. Therefore, the registrar server 171 may replace the IP address IP_{UE1} recorded in the Contact Header Field with IP_{NAT}, and store the mapping (e.g., represented as “UE1←→IP_{NAT}”) between the first user terminal 11 and the NAT device 15 as the first registration information 200. The first registration information 200 may also comprise other registration information of the first user terminal 11.

If the registration of the first user terminal 11 succeeds, then the signaling control system 17 may send a response signal 24 (e.g. “200 OK”) to the NAT device 15 after the first registration information 200 of the first user terminal 11 is stored. The NAT device 15 may generate a response signal 26 (e.g. “200 OK”) according to the mapping between the IP address/port number IP_{UE1}/P_{SIP1} of the first user terminal 11 and the IP address/port number IP_{NAT}/P′_{SIP1} of the NAT device 15 that are recorded in the Mapping Table, and then transmit the response signal 26 to the first user terminal 11. Once the response signal 26 is received by the first user terminal 11, the registration of the first user terminal 11 is completed.

Likewise, the transmission of a registration signal 20 from the second user terminal 13 to the registrar server 171 must be done through the NAT device 15. The registration signal 20 may comprise IP/UDP information and SIP information. The IP/UDP information may be a variety of IP/UDP-based information, including but not limited to the connection location information of the second user terminal 13 and the signaling control system 17 in the network layer and the transport layer. For example, “IP_{UE2}/P_{SIP2}” (corresponding to the IP address/port number of the second user terminal 13) may be recorded in a Src Header Field, and “IP_{IMS}/P_{IMS}” (corresponding to the IP address/port number of the signaling control system 17) may be recorded in a Dst Header Field.

The SIP information may be a variety of SIP-based information, including but not limited to the ID information and contact information of the second user terminal 13. For example, “UE2@IMS” may be recorded in a Request-URI Header Field to identify the second user terminal 13, and “UE2@IP_{UE2}/P_{SIP2}” may be recorded in a Contact Header Field to provide the connection location of the second user terminal 13 in the application layer.

Likewise, after receiving the registration signal 20, the NAT device 15 may generate a registration signal 22 by translating the IP address/port number IP_{UE2}/P_{SIP2} recorded in the Src Header Field into the IP address/port number IP_{NAT}/P′_{SIP2} of the NAT device 15, and then transmit the registration signal 22 to the signaling control system 17. Additionally, the NAT device 15 may store in the Mapping Table the mapping (e.g., represented as “IP_{UE2}/P_{SIP2}←→IP_{NAT}/P′_{SIP2}”) between the IP address/port number IP_{UE2}/P_{SIP2} of the second user terminal 13 and the IP address/port number IP_{NAT}/P′_{SIP2} of the NAT device 15.

Likewise, after receiving the registration signal 22, the registrar server 171 may process the registration request of the second user terminal 13, and store second registration information 202 of the second user terminal 13. For example, the registrar server 171 may learn that the IP address/port number IP_{UE2}/P_{-SIP2} recorded in the Contact Header Field is different from the IP address/port number IP_{NAT}/P′_{SIP2} recorded in the Src Header Field by comparing the IP/UDP information with the SIP information, and accordingly determine that the registration signal 22 is actually transmitted by the second user terminal 13 via the NAT device 15. Therefore, the registrar server 171 may replace the IP address IP_{UE2} recorded in the Contact Header Field with IP_{NAT}, and store the mapping (e.g., represented as “UE2←→IP_{NAT}”) between the second user terminal 13 and the NAT device 15 as the second registration information 202. The second registration information 202 may also comprise other registration information of the second user terminal 13.

Likewise, if the registration of the second user terminal 13 succeeds, then the signaling control system 17 may send a response signal 24 (e.g. “200 OK”) to the NAT device 15 after the second registration information 202 of the second user terminal 13 is stored. The NAT device 15 may generate a response signal 26 (e.g. “200 OK”) according to the mapping between the IP address/port number IP_{UE2}/P_{SIP2} of the second user terminal 13 and the IP address/port number IP_{NAT}/P′_{SIP1} of the NAT device 15 that are recorded in the Mapping Table, and then transmit the response signal 26 to the second user terminal 13. Once the response signal 26 is received by the second user terminal 13, the registration of the second user terminal 13 is completed.

The application layer gateway server 173 may be configured to determine whether the first user terminal 11 and the second user terminal 13 are located under the same NAT device according to the first registration information 200 and the second registration information 202 during a process where the first user terminal 11 and the second user terminal 13 create a session connection, and to forward first SDP information of the first user terminal 11 to the second user terminal 13 and second SDP information of the second user terminal 13 to the first user terminal 11 if it is determined that the first user terminal 11 and the second user terminal 13 are located under the same NAT device.

For example, the application layer gateway server 173 may be a computer device capable of controlling a session preformed between the first user terminal 11 and the second user terminal 13. The computer device may have various computing elements (e.g., processors, microprocessors, etc) for executing various logic operations. The computer device may have various storage elements (e.g., memories, hard disks, etc.) for storing various data. The computer device may have various input/output elements (e.g., mice, keyboards, user interfaces, screens, etc) for receiving data from the outside and outputting data to the outside. The computer device may control the session performed between the first user terminal 11 and the second user terminal 13 via elements such as the aforesaid computing elements, storage elements and input/output elements according to a processing flow constructed by software, firmware, a program, an algorithm or the like.

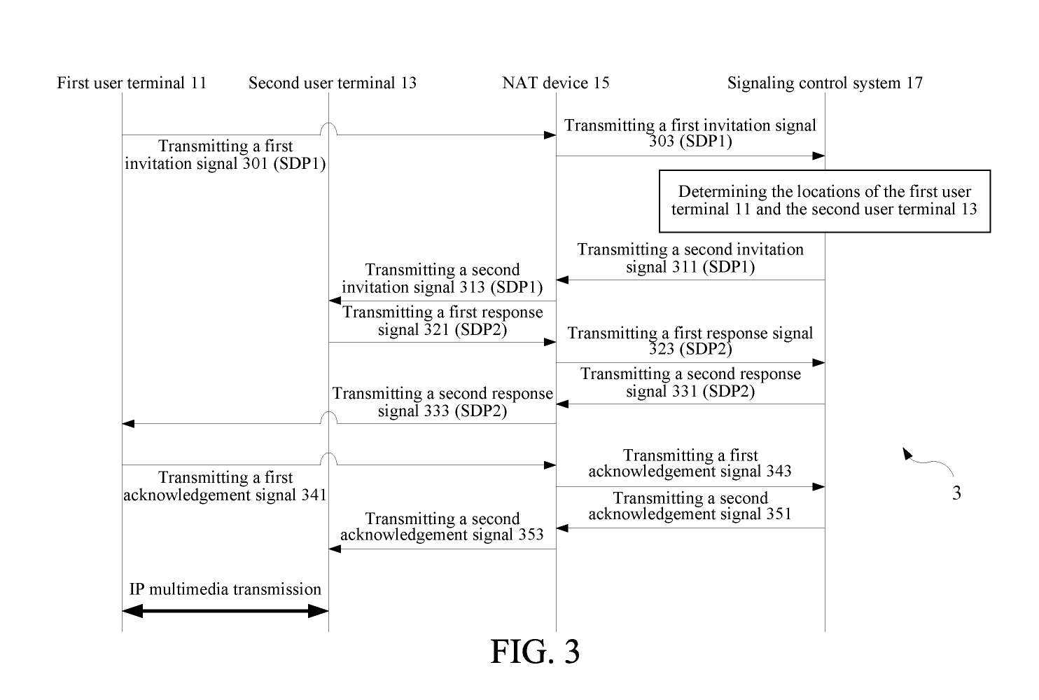

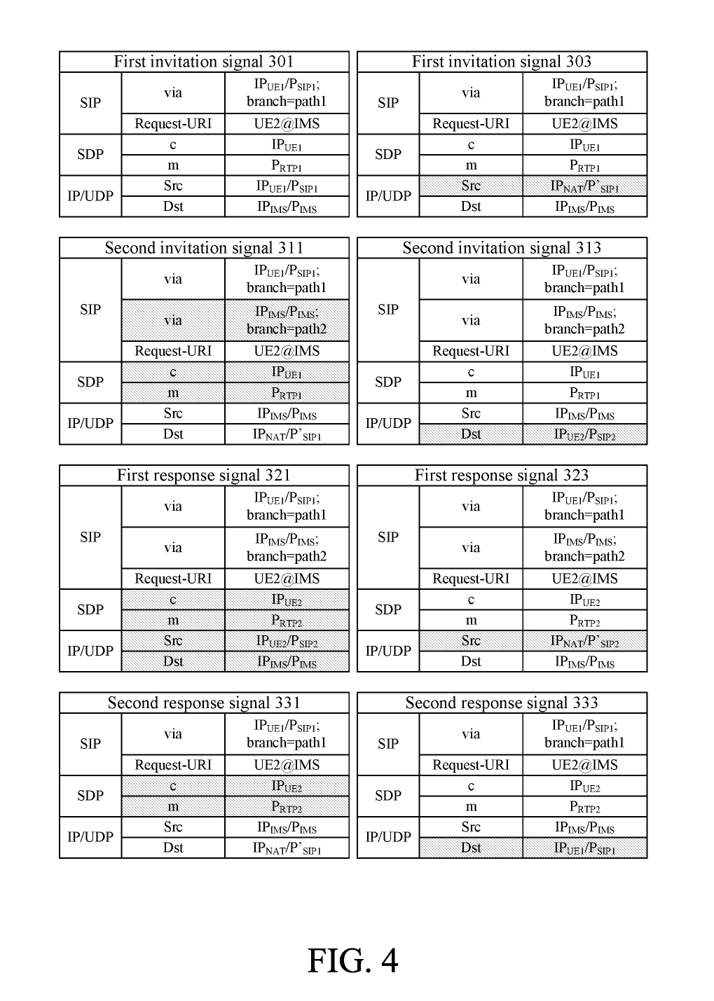

A way in which the application layer gateway server 173 controls the session performed between the user terminal 11 and the second user terminal 13 will be described hereinafter as an example with FIG. 3 and FIG. 4, but this example is not a limitation. FIG. 3 illustrates a way 3 in which the NAT traversal system operates according to one or more embodiments of the present invention, and FIG. 4 illustrates information included in the invitation signals and the response signals shown in FIG. 3 according to one or more embodiments of the present invention. Referring to FIG. 1 to FIG. 4, the session between the first user terminal 11 and the second user terminal 13 may begin with a first invitation signal 301 initiated by the first user terminal 11. Because the first user terminal 11 does not know contact information (e.g. second SDP information SDP2) of the second user terminal 13, the first user terminal 11 will firstly transmit the first invitation signal 301 to the signaling control system 17. Because the first user terminal 11 and the signaling control system 17 are located in different networks (i.e., one is located in the private network 100 and another one is located in the public network 102 respectively), transmission of the first invitation signal 301 from the first user terminal 11 to the signaling control system 17 must be done through the NAT device 15.

The first invitation signal 301 may comprise SIP information, first SDP information SDP1, and IP/UDP information. The SIP information may be a variety of SIP-based information, including but not limited to transmission path information and contact subject information. For example, “IP_{UE1}/P_{SIP1}; branch=path 1” may be recorded in a Channel Header Field (Via) to define the transmission path of a transaction, and “UE2@IMS” may be recorded in a Request-URI Header Field to define the second user terminal 13 as a contact subject. In the Channel Header Field, a parameter “branch” may be represented as an identifier (i.e., “path1”) corresponding to the transaction, and the transmission process of the transaction begins when the first user terminal 11 initiates the first invitation signal 301 and stops when a response signal (i.e., a second response signal 333) corresponding to the first invitation signal 301 is received by the first user terminal 11.

The first SDP information SDP1 may be one a variety of SDP-based information, including but not limited to session the description information necessary for the first user terminal 11 in performing the session. For example, the IP address “IP_{UE1}” of the first user terminal 11 may be recorded in a Connection Data Field (i.e., the “c Field”), and a port number “P_{RTP1}” of the first user terminal 11 may be recorded in a Media Description Field (i.e., the “m Field”).

The IP/UDP information may be a variety of IP/UDP-based information, such as but not limited to the connection location information of the first user terminal 11 and the signaling control system 17 in the network layer and the transport layer. For example, “IP_{UE1}/P_{SIP1}” (corresponding to the IP address/port number of the first user terminal 11) may be recorded in a Src Header Field, and “IP_{IMS}/P_{IMS}” (corresponding to the IP address/port number of the signaling control system 17) may be recorded in a Dst Header Field.

After receiving the first invitation signal 301, the NAT device 15 may generate a first invitation signal 303 by translating the IP address/port number IP_{UE1}/P_{SIP1} recorded in the Src Header Field into the IP address/port number IP_{NAT}/P′_{SIP1} of the NAT device 15, and then transmit the first invitation signal 303 to the signaling control system 17.

After receiving the first invitation signal 303, the application layer gateway server 173 may compare the IP/UDP information with the SIP information. Because the IP address/port number IP_{UE1}/P_{SIP1} recorded in the Channel Header Field is different from the IP address/port number IP_{NAT}/P′_{SIP1} recorded in the Src Header Field, the application layer gateway server 173 may determine that the first invitation signal 303 is actually transmitted by the first user terminal 11 via the NAT device 15. Additionally, the application layer gateway server 173 may learn from the “UE2@IMS” recorded in the Request-URI Header Field that the contact subject (i.e., the subject performing the session with the first user terminal 11) is the second user terminal 13. The application layer gateway server 173 may then determine whether the first user terminal 11 and the second user terminal 13 are located under a same NAT device according to the first registration information 200 of the first user terminal 11 and the second registration information 202 of the second user terminal 13.

The application layer gateway server 173 may, from the first registration information 200, learn that the first user terminal 11 registers with the registrar server 171 via a certain NAT device (e.g., “a first NAT device”) and learn the IP address information (e.g., IP address) of the first NAT device. Likewise, the application layer gateway server 173 may, from the second registration information 202, learn that the second user terminal 13 registers with the registrar server 171 via a certain NAT device (e.g., “a second NAT device”) and learn the IP address information (e.g., IP address) of the second NAT device. Because both the first user terminal 11 and the second user terminal 13 actually register with the registrar server 171 via the NAT device 15, the application layer gateway server 173 can learn by comparing the IP address (i.e., “IP_{NAT}”) of the first NAT device with the IP address (i.e., “IP_{NAT}”) of the second NAT device that the first NAT device and the second NAT device are actually a same NAT device (i.e., NAT device 15). At this point, the application layer gateway server 173 can identify that both the first user terminal 11 and the second user terminal 13 are located under the NAT device 15.

If the NAT device 15 can provide only one public IP address, then the application layer gateway server 173 may determine whether the IP address of the first NAT device is the same as the IP address of the second NAT device. If they are the same, the application layer gateway server 173 can identify that the first NAT device and the second NAT device are the same NAT device (i.e., identify that the first user terminal 11 and the second user terminal 13 are located under the same NAT device).

If a plurality of public IP addresses can be provided by the NAT device 15, for example, by means of an IP Pool or prefixes, then the application layer gateway server 173 may determine whether both of the IP address of the first NAT device and the IP address of the second NAT device fall in the range of the public IP addresses provided. If both of the IP address of the first NAT device and the IP address of the second NAT device fall in the range of the public IP addresses, the application layer gateway server 173 can identify that the first NAT device and the second NAT device are the same NAT device (i.e., identify that the first user terminal 11 and the second user terminal 13 are located under the same NAT device).

Unlike the conventional NAT traversal technology, the signaling control system 17 will not play the role of an agent for the first user terminal 11 if it is determined that the first user terminal 11 and the second user terminal 13 are located under the same NAT device. In detail, the application layer gateway server 173 will generate a second invitation signal 311 based on the first invitation signal 303 and transmit the second invitation signal 311 to the NAT device 15 if it is determined that the first user terminal 11 and the second user terminal 13 are located under the same NAT device.

The second invitation signal 311 may comprise SIP information, the first SDP information SDP1 and IP/UDP information. The SIP information included in the second invitation signal 311 may be a variety of SIP-based information, including but not limited to transmission path information and contact subject information. As in the first invitation signal 311, “IP_{UE1}/P_{SIP1}; branch=path1” may also be recorded in the Channel Header Field and “UE2@IMS” may also be recorded in the Request-URI Header Field in the second invitation signal 311. Besides, an additional Channel Header Field may be added and be recorded with “IP_{-IMS}/P_{IMS}; branch=path2” therein to define the transmission path of another transaction. The new transaction begins when the application layer gateway sever 173 initiates the second invitation signal 311 and stops when a response signal (i.e., a first response signal 323) corresponding to the second invitation signal 311 is received by the application layer gateway server 173.

The application layer gateway server 173 may record the “path2” recorded by the parameter “branch” in the another Channel Header Field as a transaction ID, and store the transaction ID into a transaction ID table for use in subsequent identification of this transaction. In other embodiments, the application layer gateway sever 173 may also attach to the second invitation signal 311 a transaction ID corresponding to the new transaction by other means, and store the transaction ID into the transaction ID table.

Unlike the conventional NAT traversal technology, the application layer gateway server 173 will not modify the first SDP information SDP1 of the first invitation signal 303. Instead, the application layer gateway server 173 will attach the first SDP information SDP1 of the first invitation signal 303 directly to the second invitation signal 311. In other words, the IP address “IP_{UE1}” of the first user terminal 11 may also be recorded in a Connection Data Field and the port number “P_{PTR1}” of the first user terminal 11 may also be recorded in a Media Description Field in the second invitation signal 311.

The IP/UDP information included in the second invitation signal 311 may be a variety of IP/UDP-based information, such as but not limited to the connection location information of the signaling control system 17 and the NAT device 15 in the network layer and the transport layer. For example, “IP_{IMS-}/P_{IMS}” (corresponding to the IP address/port number of the signaling control system 17) may be recorded in a Src Header Field, and “IP_{NAT}/P′_{UE2}” (corresponding to the IP address/port number of the NAT device 15) may be recorded in a Dst Header Field.

After receiving the second invitation signal 311, the NAT device 15 may generate a second invitation signal 313 by translating the IP address/port number IP_{NAT}/P′_{UE2} recorded in the Dst Header Field into the IP address/port number IP_{UE2}/P_{SIP2} of the second user terminal 13, and then transmit the second invitation signal 313 to the second user terminal 13.

After receiving the second invitation signal 313, the second user terminal 13 may acquire the first SDP information SDP1 from the second invitation signal 313. Thus, the second user terminal 13 may learn from the first SDP information SDP1 the IP address/port number IP_{UE1}/P_{SIP1} of the first user terminal 11 in the SDP layer. The second user terminal 13 may generate a first response signal 321 (e.g., “200 OK”) in response to the second invitation signal 313 and transmit the first response signal 321 (e.g., “200 OK”) to the NAT device 15.

The first response signal 321 may comprise the SIP information included in the second invitation signal 313, second SDP information SDP2 and IP/UDP information. The second SDP information SDP2 may be a variety of SDP-based information, including but not limited to the session description information necessary for the second user terminal 13 in performing a session. For example, the IP address “IP_{UE2}” of the second user terminal 13 may be recorded in a Connection Data Field, and the port number “P_{RTP2}” of the second user terminal 13 may be recorded in a Media Description Field. The IP/UDP information included in the first response signal 321 may be a variety of IP/UDP-based information, such as but not limited to connection location information of the second user terminal 13 and the signaling control system 17 in the network layer and the transport layer. For example, “IP_{UE2}/P_{SIP2}” (corresponding to the IP address/port number of the second user terminal 13) may be recorded in a Src Header Field, and “IP_{IMS}/P_{IMS}” (corresponding to the IP address/port number of the signaling control system 17) may be recorded in a Dst Header Field.

After receiving the first response signal 321, the NAT device 15 may generate a first response signal 323 (e.g., “200 OK”) by translating the IP address/port number IP_{UE2}/P_{SIP2} recorded in the Src Header Field into the IP address/port number IP_{NAT}/P′_{UE2} of the NAT device 15, and then transmit the first response signal 323 to the signaling control system 17.

After receiving the first response signal 323, the application layer gateway server 173 may transmit a second response signal 331 (e.g., “200 OK”) to the NAT device 15. The second response signal 331 may comprise the SIP information included in the first invitation signal 303, the second SDP information SDP2 and IP/UDP information. Because the “path2” recorded by the parameter “branch” in the another Channel Header Field has been recorded in the transaction ID table, the application layer gateway server 173 can identify that the first response signal 323 is just a response signal to the second invitation signal 313, and learn that the another transaction is completed.

Unlike the conventional NAT traversal technology, the application layer gateway server 173 will not modify the second SDP information SDP2 in the first response signal 323. Instead, the application layer gateway server 173 will attach the second SDP information SDP2 in the first response signal 323 directly to the second response signal 331. In other words, the IP address “IP_{UE2}” of the second user terminal 13 may also be recorded in a Connection Data Field and the port number “P_{RTP2}” of the second user terminal 13 may also be recorded in a Media Description Field in the second response signal 331. The IP/UDP information included in the second response signal 331 may be a variety of IP/UDP-based information, such as but not limited to connection location information of the signaling control system 17 and the NAT device 15 in the network layer and the transport layer. For example, “IP_{IMS}/P_{IMS}” (corresponding to the IP address/port number of the signaling control system 17) may be recorded in a Src Header Field, and “IP_{NAT}/P′_{UE1}” (corresponding to the IP address/port number of the NAT device 15) may be recorded in a Dst Header Field.

After receiving the second response signal 331, the NAT device 15 may generate a second response signal 333 (e.g., “200 OK”) by translating the IP address/port number IP_{NAT}/P′_{UE1} recorded in the Dst Header Field into the IP address/port number IP_{UE1}/P_{SIP1} of the NAT device 15, and then transmit the second response signal 333 to the first user terminal 11.

After receiving the second response signal 333, the first user terminal 11 may acquire the second SDP information SDP2 from the second response signal 333. Therefore, the first user terminal 11 can learn from the second SDP information SDP2 the IP address/port number IP_{UE2}/P_{SIP2} of the second user terminal 13 in the SDP layer.

After receiving the second response signal 333, the first user terminal 11 may transmit a first acknowledgement signal 341 (e.g., “ACK”) to the NAT device 15. The NAT device 15 translates the first acknowledgement signal 341 into a first acknowledgement signal 343 (e.g., “ACK”), and then transmits the first acknowledgement signal 343 to the signaling control system 17. The signaling control system 17 may transmit a second acknowledgement signal 351 (e.g., “ACK”) to the NAT device 15 in response to the first acknowledgement signal 343. The NAT device 15 translates the second acknowledgement signal 351 into a second acknowledgement signal 353 (e.g., “ACK”), and then transmits the second acknowledgement signal 353 to the second user terminal 13. After the second acknowledgement signal 353 is received by the second user terminal 13, a session connection may be created between the first user terminal 11 and the second user terminal 13 in the NAT device 15 (i.e., in the private network 100) so that an Internet multimedia transmission can be directly performed on the session connection.

For definitions of SIP, SDP and IP/UDP as well as the details of various header fields included therein, reference may be made to the Request For Comments (RFC) issued by the Internet Engineering Task Force (IETF). The RFC is a series of files arranged by serial numbers, which comprises various protocols and standards related to the Internet.

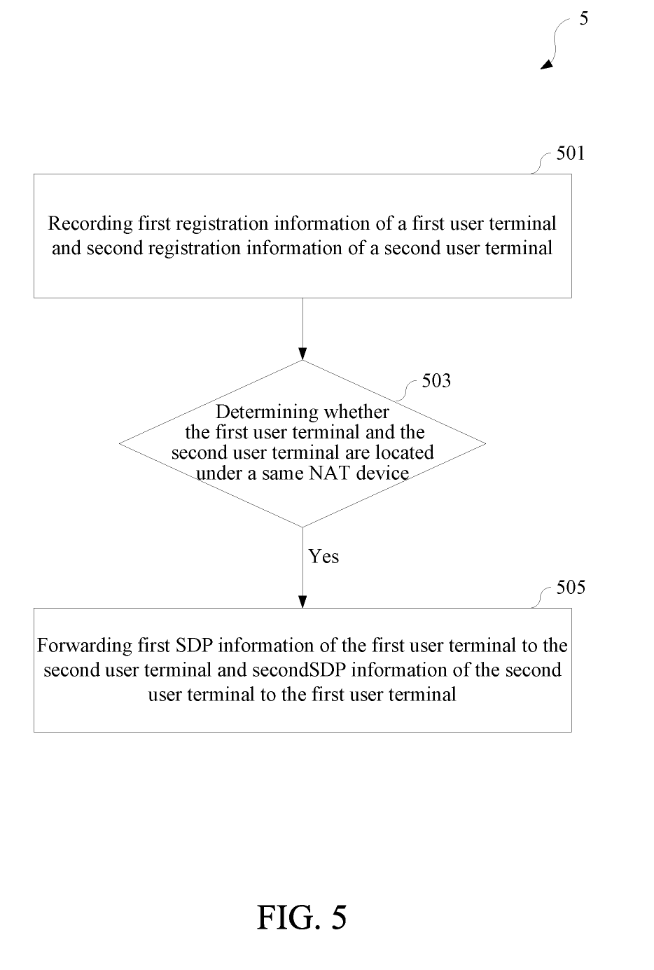

One or more embodiments of the present invention may be a signaling control method for use in a NAT traversal system. The signaling control method may be used in the NAT traversal system 1. The signaling control method will be described as an example with FIG. 5, but this example is not a limitation. FIG. 5 illustrates a signaling control method for use in a NAT traversal system according to one or more embodiments of the present invention.

Referring to FIG. 5, a signaling control method 5 for use in a NAT traversal system may comprise the following steps: recording by a signaling control system first registration information of a first user terminal and second registration information of a second user terminal (corresponding to Step 501); determining by the signaling control system whether the first user terminal and the second user terminal are located under a same NAT device according to the first registration information and the second registration information during a process where the first user terminal and the second user terminal create a session connection (corresponding to Step 503); and forwarding by the signaling control system first SDP information of the first user terminal to the second user terminal and second SDP information of the second user terminal to the first user terminal if it is determined that the first user terminal and the second user terminal are located under the same NAT device (corresponding to Step 505).

In other embodiments, the signaling control method 5 may be implemented based on the following conditions: the first user terminal registers with the signaling control system via a first NAT device; the second user terminal registers with the signaling control system via a second NAT device; the first registration information comprises IP address information of the first NAT device; the second registration information comprises IP address information of the second NAT device; and the signaling control system determines whether the first user terminal and the second user terminal are located under a same NAT device by comparing the IP address information of the first NAT device with the IP address information of the second NAT device.

In other embodiments, the signaling control method 5 may further comprise the following steps: transmitting by the signaling control system a second invitation signal to the second user terminal via the same NAT device after receiving a first invitation signal initiated by the first user terminal, wherein the first invitation signal comprises the first SDP information of the first user terminal and a first transaction ID, and the second invitation signal comprises the first SDP information of the first user terminal, the first transaction ID and a second transaction ID; and after a first response signal initiated by the second user terminal via the same NAT device in response to the second invitation signal is received, determining by the signaling control system whether the first response signal comprises the second transaction ID, and if the signaling control system determines that the first response signal comprises the second transaction ID, then transmitting by the signaling control system a second response signal to the first user terminal via the same NAT device, wherein the first response signal comprises the second SDP information of the second user terminal, and the second response signal comprises the second SDP information of the second user terminal.

In other embodiments, the signaling control method 5 may further comprise the following steps: transmitting by the signaling control system a second invitation signal to the second user terminal via the same NAT device after receiving a first invitation signal initiated by the first user terminal, wherein the first invitation signal comprises the first SDP information of the first user terminal and a first transaction ID, and the second invitation signal comprises the first SDP information of the first user terminal, the first transaction ID and a second transaction ID; and after a first response signal initiated by the second user terminal via the same NAT device in response to the second invitation signal is received, determining by the signaling control system whether the first response signal comprises the second transaction ID, and if the signaling control system determines that the first response signal comprises the second transaction ID, then transmitting by the signaling control system a second response signal to the first user terminal via the same NAT device, wherein the first response signal comprises the second SDP information of the second user terminal, and the second response signal comprises the second SDP information of the second user terminal. Additionally, each of the first transaction ID and the second transaction ID corresponds to a branch parameter in a channel field of a session initiation protocol.

In fact, the signaling control method 5 may execute all the operations of the signaling control system 17. Corresponding steps of the signaling control method 5 in executing these operations of the signaling control system 17 can be known by those of ordinary skill in the art directly from the above description of the signaling control system 17, so the related details thereof will not be further described herein.

In summary, unlike the conventional NAT traversal technology, the various aspects and embodiments of the present invention may determine whether a caller (e.g., the first user terminal) and a callee (e.g., the second user terminal) are located under a same NAT device according to the registration information of the caller and the callee. The various aspects and embodiments of the present invention may forward the SDP information of the caller directly to the callee and forward the SDP information of the callee directly to the caller if it is determined that the caller and the callee are located in the same NAT device. In such a way, once a session connection has been created between the caller and the callee, the caller and the callee can communicate with each other directly without the need of agency of the signaling control system and translation by the NAT device. In other words, the various aspects and embodiments of the present invention allow any two user terminals located under a same NAT device to communicate with each other directly. Thereby, as compared with the conventional NAT traversal technology, the times of transmission and the times of transition that need to be experienced during a session between the two user terminals can be effectively reduced.

The above disclosure is related to the detailed technical contents and inventive features thereof. People skilled in this art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signaling control system for use in a network address translation (NAT) traversal system, comprising:
a registrar server, configured to record first registration information of a first user terminal and second registration information of a second user terminal; and
an application layer gateway server, configured to determine whether the first user terminal and the second user terminal are located under a same NAT device according to the first registration information and the second registration information during a process where the first user terminal and the second user terminal create a session connection, and forward first session description protocol (SDP) information of the first user terminal to the second user terminal and forward second SDP information of the second user terminal to the first user terminal if it is determined that the first user terminal and the second user terminal are located under the same NAT device.

2. The signaling control system of claim 1, wherein the first user terminal registers with the registrar server via a first NAT device, the second user terminal registers with the registrar server via a second NAT device, the first registration information comprises Internet Protocol (IP) address information of the first NAT device, the second registration information comprises IP address information of the second NAT device, and the application layer gateway server determines whether the first user terminal and the second user terminal are located under the same NAT device by comparing the IP address information of the first NAT device with the IP address information of the second NAT device.

3. The signaling control system of claim 1, wherein:
the application layer gateway server transmits a second invitation signal to the second user terminal via the same NAT device after receiving a first invitation signal initiated by the first user terminal, the first invitation signal comprises the first SDP information of the first user terminal and a first transaction identification (ID), and the second invitation signal comprises the first SDP information of the first user terminal, the first transaction ID and a second transaction ID; and
after receiving a first response signal initiated by the second user terminal via the same NAT device in response to the second invitation signal, the application layer gateway server determines whether the first response signal comprises the second transaction ID, and if the application layer gateway server determines that the first response signal comprises the second transaction ID, then the application layer gateway server transmits a second response signal to the first user terminal via the same NAT device, the first response signal comprises the second SDP information of the second user terminal, and the second response signal comprises the second SDP information of the second user terminal.

4. The signaling control system of claim 3, wherein each of the first transaction ID and the second transaction ID corresponds to a branch parameter in a channel field of a session initiation protocol.

5. A signaling control method for use in a NAT traversal system, the method comprising:
recording by a signaling control system first registration information of a first user terminal and second registration information of a second user terminal; and
determining by the signaling control system whether the first user terminal and the second user terminal are located under a same NAT device according to the first registration information and the second registration information during a process where the first user terminal and the second user terminal create a session connection, and forwarding by the signaling control system first session description protocol (SDP) information of the first user terminal to the second user terminal and second SDP information of the second user terminal to the first user terminal if it is determined that the first user terminal and the second user terminal are located under the same NAT device.

6. The signaling control method of claim 5, wherein the first user terminal registers with the signaling control system via a first NAT device, the second user terminal registers with the signaling control system via a second NAT device, the first registration information comprises IP address information of the first NAT device, the second registration information comprises IP address information of the second NAT device, and the signaling control system determines whether the first user terminal and the second user terminal are located under the same NAT device by comparing the IP address information of the first NAT device with the IP address information of the second NAT device.

7. The signaling control method of claim 5, further comprising:
transmitting by the signaling control system a second invitation signal to the second user terminal via the same NAT device after receiving a first invitation signal initiated by the first user terminal, wherein the first invitation signal comprises the first SDP information of the first user terminal and a first transaction ID, and the second invitation signal comprises the first SDP information of the first user terminal, the first transaction ID and a second transaction ID; and
after a first response signal initiated by the second user terminal via the same NAT device in response to the second invitation signal is received, determining by the signaling control system whether the first response signal comprises the second transaction ID, and if the signaling control system determines that the first response signal comprises the second transaction ID, then transmitting by the signaling control system a second response signal to the first user terminal via the same NAT device, wherein the first response signal comprises the second SDP information of the second user terminal, and the second response signal comprises the second SDP information of the second user terminal.

8. The signaling control method of claim 7, wherein each of the first transaction ID and the second transaction ID corresponds to a branch parameter in a channel field of a session initiation protocol.
